(19) United States
(12) Patent Application Publication
(10) Pub. No.: US 2022/0138307 A1
(43) Pub. Date: May 5, 2022

(54) Automated Mobile Device Staging System

(71) Applicant: ZEBRA TECHNOLOGIES CORPORATION, Lincolnshire, IL (US)

(72) Inventors: Deepak Ayyagari, Bangalore (IN); Allan Perry Herrod, Mission Viejo, CA (US)

(21) Appl. No.: 17/086,779

(22) Filed: Nov. 2, 2020

(51) Int. Cl. G06F 21/44; G06F 1/16

(52) U.S. Cl. CPC G06F 21/44; G06F 1/1632

(57) ABSTRACT

A method of staging mobile computing devices includes, at a computing device: receiving a staging request from a mobile computing device in response to insertion of the mobile computing device in a network-connected charging rack; selecting a source of staging data to fulfill the staging request; sending a source identifier of the selected source of staging data to the mobile computing device; and in response to sending the source identifier of the selected source of staging data, sending an access control command to the network-connected charging rack to lock the mobile computing device in the charging rack.

### BACKGROUND

Staging of mobile computing devices may require manual intervention by trained operators, e.g. to operate a device to scan a set of barcodes and perform other actions to prepare the device for operation. Staging can therefore be time-consuming and error-prone.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for mobile computing device staging.

FIG. 2 is a block diagram of certain internal hardware components of a client device of FIG. 1.

FIG. 3 is a flowchart of a method of staging mobile computing devices in the system of FIG. 1.

FIG. 4 illustrates a performance of blocks 305-315 of the method of FIG. 3.

FIG. 5 illustrates a performance of blocks 325-335 of the method of FIG. 3.

FIG. 6 illustrates another performance of blocks 325-335 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method of staging mobile computing devices, the method comprising, at a computing device: receiving a staging request generated from a mobile computing device in response to insertion of the mobile computing device in a network-connected charging rack; selecting a source of staging data to fulfill the staging request; sending a source identifier of the selected source of staging data to the mobile computing device; and in response to sending the source identifier of the selected source of staging data, sending an access control command to the network-connected charging rack to lock the mobile computing device in the charging rack.

Additional examples disclosed herein are directed to a computing device, comprising: a communications interface; and a processor configured to: receive a staging request from a mobile computing device in response to insertion of the mobile computing device in a network-connected charging rack; select a source of staging data to fulfill the staging request; send a source identifier of the selected source of staging data to the mobile computing device; and in response to sending the source identifier of the selected source of staging data, send an access control command to the network-connected charging rack to lock the mobile computing device in the charging rack.

Further examples disclosed herein are directed to a system, comprising: a charging rack including a plurality of cradles and a network interface interconnecting the cradles; and a computing device including a communications interface and a processor configured to: receive a staging request from a mobile computing device in response to insertion of the mobile computing device in the charging rack; select a source of staging data to fulfill the staging request; send a source identifier of the selected source of staging data to the mobile computing device; and in response to sending the source identifier of the selected source of staging data, send an access control command to the charging rack to lock the mobile computing device in the charging rack.

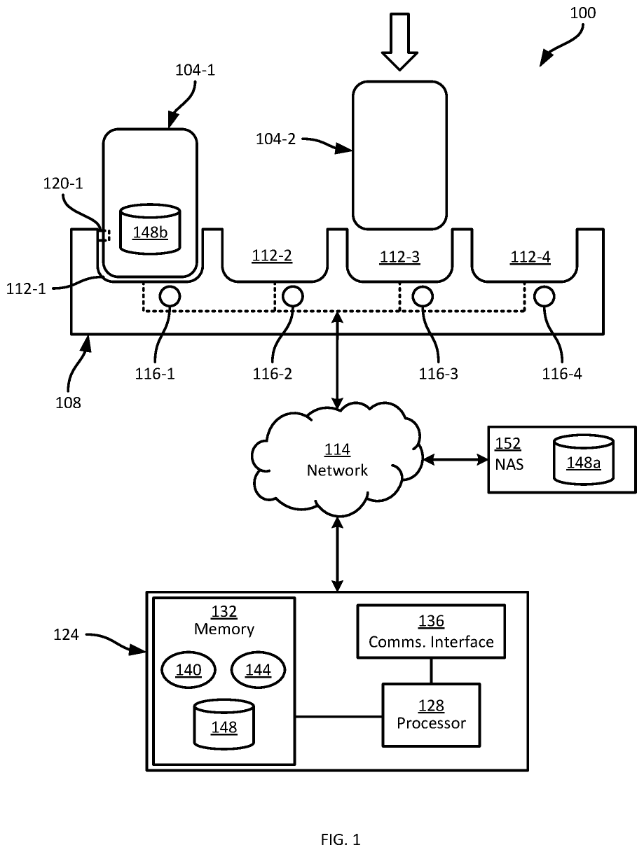

FIG. 1 depicts a system 100 including a plurality of mobile computing devices, of which two examples 104-1 and 104-2 (collectively referred to as the mobile computing devices 104, and generically referred to as a mobile computing device 104) are shown. The mobile computing devices 104 are also referred to herein simply as devices 104. The devices 104 can include any one of, or any combination of, handheld or wearable computers, barcode scanners, smartphones, tablet computers, label printers, or the like. Each device 104 thus includes a variety of internal components (e.g. controllers, displays, barcode reader modules, or the like), powered by an integrated battery.

A plurality of the devices 104 may be deployed in a facility, such as a warehouse, supermarket, healthcare facility, or the like. The functions performed by the devices 104 vary based on the environment in which the devices 104 are deployed, and can include any one of, or any combination of, printing labels, scanning barcodes, capturing images, receiving and displaying instructions (e.g. pick instructions in a warehouse) for an operator, and the like.

Prior to deployment in a given facility, each device 104 is configured for operation in that facility. That is, the device 104 is received at the facility from a device manufacturer in a state that generally includes an operating system, but does not include various facility-specific software to enable the device 104 to perform the tasks for which the device 104 will be deployed in the facility. Preparing each device 104 to operate in the relevant facility is referred to as staging the device 104, and includes one or more of the installation of applications, configuration of settings (e.g. network connections), and retrieval of other data to enable the device to operate within the facility.

Various mechanisms may be employed to stage a device 104. For example, when the devices 104 include barcode reader modules, a device 104 can be operated to scan one or more previously generated barcodes and retrieve therefrom instructions and/or storage locations for staging data. In other examples, a device 104 may be operated to establish a connection to another, previously staged, device 104, and retrieve staging data therefrom in what is referred to as peer-to-peer (P2P) staging. In further examples, a device 104 can be placed into a charging cradle that is connected to a network, and the device 104 may then be operated to initiate staging, e.g. by retrieving staging data from a source previously made available via the charging cradle. The above staging mechanisms, however, involve manual operation of each device 104 by staging staff, and may therefore be time-consuming and error-prone.

The system 100 includes certain components and functionality to reduce manual intervention by staging staff, enabling staging of devices 104 that is automated to a greater degree than in the mechanisms mentioned above.

In particular, the system 100 includes a charging rack 108, including a plurality of cradles 112-1, 112-2, 112-3, and 112-4. The rack 108 can include other numbers of cradles 112 smaller or greater than four in other examples, including as few as two cradles 112. Each cradle 112 includes charging contacts to engage with a charging interface of the devices 104. The rack 108 also includes a communications interface to connect to a network 114 such as a local area network (LAN), e.g. an Ethernet-based LAN, and each cradle 112 includes connections to the above-mentioned interface. In this example, the rack 108 includes a local network switch enabling both communications between cradles 112, and communications between the cradles 112 and the network 114.

In this example the rack 108 also includes, in association with each cradle 112, an indicator 116 such as a light or a set of lights. The rack 108 as illustrated in FIG. 1 therefore includes four indicators 116-1, 116-2, 116-3, and 116-4 (one for each cradle 112). The indicators 116 can be controlled to indicate various state information for the devices 104 in the rack 108. Such control can be effected by a local controller of the rack 108, which may select and apply control states to the indicators 116 in response to various conditions, and/or in response to commands from another computing device connected to the network 114. In other examples, the indicators 116 may be omitted.

The rack 108, in the illustrated example, also includes a restraining mechanism associated with each cradle 112, to lock a device 104 within the cradle 112. For example, a lock 120-1 is shown in an extended position, locking the device 104-1 in the cradle 112-1. Each cradle 112 can include such a lock, and the locks can be controlled by the controller of the rack 108, e.g. in response to commands from another computing device. In some examples, the locks can be omitted, or replaced with other retaining mechanisms such as switchable electromagnets and the like.

The devices 104 are staged in the system 100 by placement into available cradles 112 in the rack 108. For example, while the device 104-1 is assumed to have been previously staged (and may simply have been placed in the cradle 112-1 to charge a battery), the device 104-2 is assumed to be un-staged. Staging of the device 104-2 is therefore initiated by inserting the device 104-2 into an empty cradle 112 (the cradle 112-3, in the illustrated example).

The system 100 also includes a computing device such as a server 124 connected to the network 114. The server 124 implements various functions for staging the devices 104, including controlling certain features of the rack 108, as well as selecting and controlling sources of staging data for use by the devices 104.

The server 124 includes a central processing unit (CPU), also referred to as a processor 128, interconnected with a non-transitory computer readable storage medium, such as a memory 312. The memory 312 includes any suitable combination of volatile (e.g. Random Access Memory (RAM)) and non-volatile (e.g. read only memory (ROM), Electrically Erasable Programmable Read Only Memory (EEPROM), flash) memory. The processor 128 and the memory 132 each comprise one or more integrated circuits (ICs).

The server 124 also includes a communications interface 136, enabling the server 124 to exchange data with other computing devices, such as the devices 104 and the controller of the rack 108 via the network 114. The communications interface 136 therefore includes any suitable hardware (e.g. transmitters, receivers, network interface controllers and the like) allowing the server 124 to communicate, e.g. over the network 114.

The memory 132 stores a plurality of computer-readable instructions, e.g. in the form of a staging control application 140 and an access control application 144. The applications 140 and 144 are executable by the processor 128 to implement various functionality performed by the server 124. As will be discussed below, the application 140 implements functionality to detect new devices 104 to be staged, and to select a source of staging date for such devices. The staging data includes, for example, one or more staging files that contain applications, configuration settings, and the like, and/or instructions for where to retrieve such information. The memory 132 stores, in this example, a repository 148 of staging data. The server 124, however, may not be the only source of staging data in the system 100. In fact, in some examples, the server 124 may not host any staging data.

Another example of staging data source is a network-attached storage (NAS) device 152 containing a copy 148a of the staging data. A further example of a staging data source is the device 104-1, which contains a further copy 148b of the staging data, acquired when the device 104-1 itself was staged. As will be apparent to those skilled in the art, the server 124 and the NAS 152 may maintain staging data for a plurality of difference device types, while the device 104-1 may store staging data for only one device type (i.e. the type of the device 104-1 itself). However, for simplicity of illustration, in this discussion it is assumed that the staging data 148, 148a, and 148b are copies of the same staging data, used to configure the devices 104.

The server 124, having selected a source of staging data, is configured via execution of the application 144 to control access to either or both of the source, and the device 104 being staged. In some examples, the applications 140 and 144 can be implemented as a single application, or as distinct applications as shown, executed by distinct computing devices rather than the server 124.

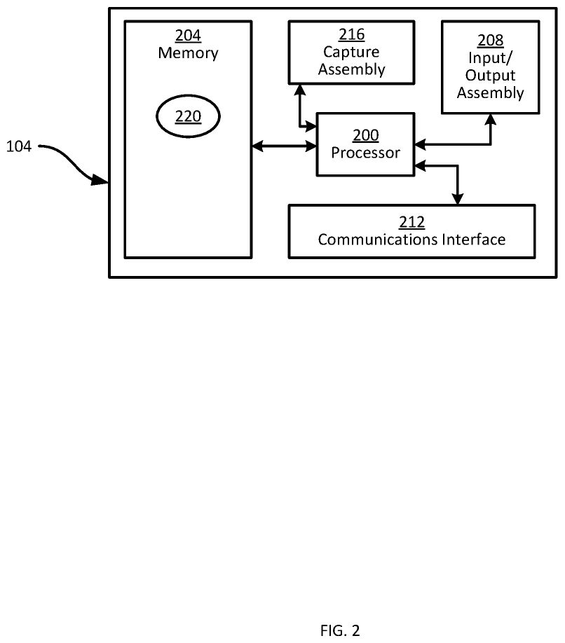

Before describing the functionality of the system 100 to stage a device 104 in greater detail, certain components of the devices 104 will be described in greater detail with reference to FIG. 2. Each of the client devices 104-1 and 104-2 in the system 100 include the components shown in FIG. 2.

The devices 104, as illustrated in FIG. 2, each include a central processing unit (CPU), also referred to as a processor 200, interconnected with a non-transitory computer readable storage medium, such as a memory 204. The memory 204 includes any suitable combination of volatile (e.g. Random Access Memory (RAM)) and non-volatile (e.g. read only memory (ROM), Electrically Erasable Programmable Read Only Memory (EEPROM), flash) memory. The processor 200 and the memory 204 each comprise one or more integrated circuits (ICs).

The device 104 also includes at least one input device, and at least one output device, illustrated in FIG. 2 as an input/output assembly 208 interconnected with the processor 200. In the present example, the input/output assembly is a touch-enabled display (i.e. a display panel with an integrated touch screen). In other examples, the input and output devices need not be integrated as shown in FIG. 2. The input device includes any suitable one, or any suitable combination of, a touch screen, a keypad, a trigger (e.g. to initiate the performance of an encoding or scanning task), a microphone and the like. The output device includes any suitable one, or any suitable combination of a display (e.g., integrated with the above-mentioned touch screen), a speaker, and the like. The input/output device 208 is configured to receive input and provide data representative of the received input to the processor 200, and to receive output from the processor 200 and present the output, e.g. via the emission of sound from the speaker, the rendering of visual indications on the display, and the like.

The device 104 also includes a communications interface 212, enabling the device 104 to exchange data with other computing devices, such as the server 124 via the network 114. The communications interface 212 therefore includes any suitable hardware (e.g. transmitters, receivers, network interface controllers and the like) allowing the device 104 to communicate, e.g. over the network 114.

The device 104 can also include a capture assembly 216, such as a camera, a barcode reader, or the like. The capture assembly 216 can be omitted in other examples, however.

The components of the device 104 are interconnected by communication buses, and powered by a battery or other power source, over the above-mentioned communication buses or by distinct power buses.

The memory 204 of the device 104 stores a plurality of applications, each including a plurality of computer readable instructions executable by the processor 200. The execution of the above-mentioned instructions by the processor 200 causes the device 104 to implement certain functionality, as discussed herein. The applications are therefore said to be configured to perform that functionality in the discussion below. In the present example, the memory 204 of the device 104 stores a staging client application 220, also referred to herein as the application 220. The device 104 is configured, via execution of the application 220 by the processor 200, to detect insertion of the device 104 into a cradle 112 of the rack 108 and initiate a staging process.

As will be apparent in the discussion below, the application 220 need not initiate the staging process when the device 104 has already been staged (e.g. as indicated by a flag stored in association with the application 220 after staging is complete). Once staging has been completed, the application 220 can also enable the device 104 to act as a source of staging data. The two sets of functionality above (staging of the device 104 itself, and acting as a staging source) can also be implemented via distinct applications in other examples.

In other examples, the processor 200, as configured by the execution of the application 220, is implemented as one or more specifically-configured hardware elements, such as field-programmable gate arrays (FPGAs) and/or application-specific integrated circuits (ASICs).

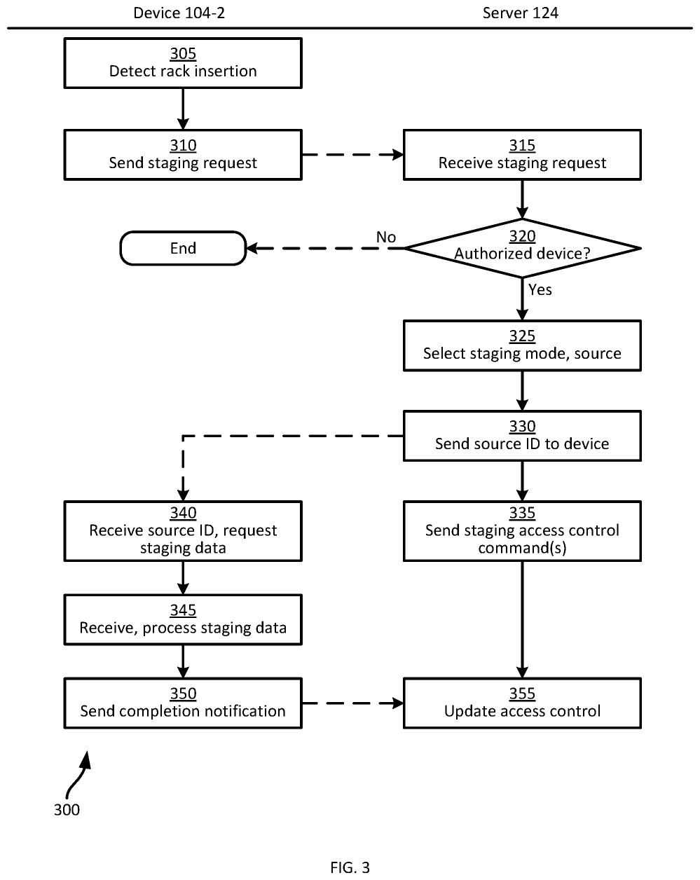

Turning now to FIG. 3, a method 300 of automatically staging mobile computing devices is illustrated. The method 300 will be described in conjunction with its performance in the system 100. More specifically, certain portions of the method 300 as described below are performed by a device 104 (specifically, the device 104-2 in this example performance of the method 300) that has not yet been staged, and other portions are performed by the server 124. As indicated in the header in FIG. 3, the blocks performed by the device 104-2 are along the left side of the flowchart, while the blocks performed by the server 124 are along the right side of the flowchart. In other examples, the actions taken by the server 124 may instead be performed by another computing device, such as a further mobile device 104.

At block 305, the device 104-2 is configured to detect that it has been inserted into the rack 108 (e.g. into the cradle 112-3). The detection can be based on, for example, a detection of electrical contact with the charging hardware of the rack 108. In other examples, the detection can be based on sensor data from magnetic sensors, optical sensors, or the like. In some examples, the device 104-2 can also be configured to determine whether the rack 108 has networking capabilities necessary for staging. As will be apparent to those skilled in the art, some charging racks lack networking functions, and may therefore not be suitable for the method 300. In further examples, the device 104-2 can also be configured to determine whether the networking capabilities of the rack 108 include a wired network connection to the server 124. For example, the device 104-2 may initiate the remainder of the method 300 only when a wired network connection is available, and to terminate the method 300 if the rack 108 has only a wireless connection.

Upon verifying that the rack 108 is network-enabled, at block 310 the device 104-2 is configured, via execution of the application 220, to send a staging request. The staging request is sent, in this example, as a broadcast message rather than a message addressed to a particular device, because the device 104-2 typically does not have an address for the server 124 in its unstaged state. The staging request, in effect, announces the presence of the device 104-2 to the local network, enabling staging components of the system 100 (such as the server 124) to detect the presence of the device 104-2 and begin staging.

At block 315, the server 124 is configured to receive the staging request sent by the device 104-2. For example, when the staging request is broadcast, the server 124 as well as any other computing devices on the network receive the staging request. The server 124, however, is configured to listen for such staging requests and take various actions upon detecting a staging request. Other computing devices on the network may simply ignore the staging request.

At block 320, the server 124 can be configured to determine whether the device 104-2 is authorized for staging in the system 100. The authorization at block 320 can be omitted in other examples. In the present example, the authorization stage enables the server 124 to prevent the staging of inappropriate devices (and therefore the provision of potentially sensitive facility information to such devices). Such devices may be malicious, or may be devices from another facility or portion of the same facility that have been accidentally placed in the rack 108.

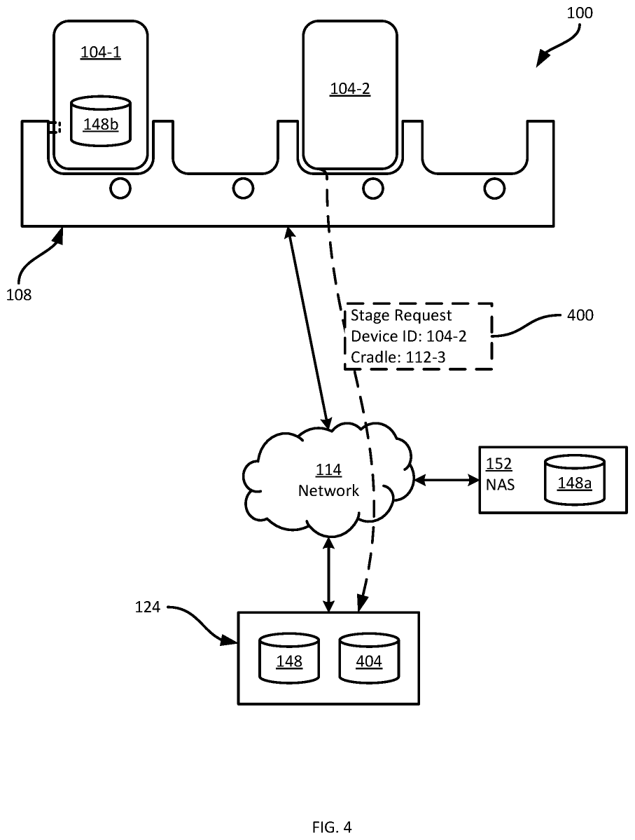

Turning to FIG. 4, an example performance of blocks 305, 310, and 315 is illustrated in the system 100. In particular, the device 104-2 is shown having been inserted into the cradle 112-3. As a result, the device 104-2 (at block 305) generates and transmits a staging request 400 via the communication interface of the rack 108. The request 400 contains, as shown in FIG. 4, a device identifier of the device 104-2 such as a serial number, a Media Access Control (MAC) address, or the like. The device identifier may be encrypted. In the illustrated example, the identifier is simply “104-2” for clarity of illustration. The request 400 can also include a port number or other identifier of the specific cradle 112 in which the device 104 was inserted. The cradle identifier may be, for example, an Internet Protocol (IP) address assigned to that specific cradle 112, and the server 124 can store a mapping of IP addresses to cradles 112 (and racks 108, when the system 100 includes multiple racks 108). In other examples, the cradle identifier can be omitted, and the rack 108 itself can be configured to send a separate message (not shown) to the server 124 indicating that a new device has been detected in an identified cradle 112.

At block 320, having received the request 400, the server 124 can be configured to compare the device identifier to a repository 404 of authorized devices. The repository 404 can be, for example, a whitelist of all device identifiers for devices authorized to operate within the facility, within the rack 108 itself, or within a specific group of racks 108 in the facility. The server 124 may therefore compare not only the device identifier to the whitelist, but the pairing of the device identifier and rack/cradle identifier. Thus, before inserting the device 104-2 in the rack 108, an operator may update the repository 404 with an identifier of the device 104-2.

When the device identifier in the request 400 is not in the repository 404, the performance of the method 300 does not proceed. Instead, the server 124 may simply ignore the request 400, or may send a command to the rack 108 to generate an error notification (e.g. via the indicators 116).

When the determination at block 320 is affirmative, however, the staging process proceeds. Returning to FIG. 3, at block 325 the server 124 is configured to select a staging mode and a staging source. As noted earlier, various sources of staging data may be available in the system 100. For example, the server 124 itself may store the staging data 148; the NAS 152 may store a copy of the staging data 148b, and other devices 104, such as the device 104-1, may also have been previously staged and therefore store a copy of the staging data 148c. In the discussion below, the staging source refers to a combination of a physical storage location for staging data, and the staging data itself. A given storage location may contain multiple sets of staging data, and thus effectively provide multiple staging sources. Conversely, the same staging data may be stored at multiple locations, each constituting a separate staging source.

The server 124 is configured to evaluate various factors when selecting a staging mode and source. In the present example, two staging modes are available: a network-hosted mode, in which staging data is obtained from a central source such as the server 124 itself or the NAS 152; and a P2P mode, in which staging data is obtained from another device 104 with a configuration that matches the desired configuration of the device 104-2. In some examples, combinations of staging sources may be selected. For example, a portion of the necessary staging data may be retrieved from one location, while another portion may be retrieved from a further location. In other words, the server 124 may select multiple staging sources. In further examples, the P2P mode may be used to provide staging data to the device 104-2 from another device 104 that does not have a matching configuration (or at least does not have a fully matching configuration). For example, the other device 104 may store the staging data purely for use as a staging source. In other examples, the other device 104 may partially match the configuration of the device 104-2, and may therefore provide a portion of the necessary staging data.

To select between the above modes, the server 124 can determine whether either or both modes are available. For example, the server 124 can determine whether the rack 108 contains any other devices 104 that contain staging data relevant to the device 104-2, and whether such devices are available to act as staging sources. If the device 104-1 is in the midst of a configuration update itself, for instance, the device 104-1 may not be available for P2P staging, and the server 124 may therefore select the network-hosted mode. The server 124 maintains a current status of each device 104 in the system 100, and can therefore determine whether any devices 104 are not currently engaged in other tasks, and are currently inserted in the rack 108.

The server 124 can also determine whether staging data 148 or 148a is available locally or at the NAS 152. In addition, when the staging data 148 or 148a is available, the server 124 may assess a current usage (e.g. computational load or the like) of the storage location of the staging data. For example, if the server 124 is currently serving the staging data 148 to a number of other devices 104, the server 124 may instead select the P2P mode for the device 104-2 (assuming the P2P mode is available), to avoid additional load on the server 124). For example, the server 124 may retrieve a current usage level associated with the server 124 itself, or the NAS 152, and compare the usage level with a threshold. If the usage level exceeds the threshold, the server 124 may select the P2P mode. The server 124 may also evaluate expected future load against the above-mentioned threshold, e.g. based on schedule data defining upcoming updates to other devices 104 that are expected to impose computational load on the server 124.

When the server 124 selects a mode, the server 124 also selects a specific source of staging data. In some instances, a given mode is available from only one source. When multiple sources are available for a given mode, such as a plurality of other devices 104 in the rack 108 that store copies of the staging data 148, the server 124 selects between the available sources. For example, the server 124 may select between available devices 104 in the rack 108 based on a current battery level of the devices. The server 124 may select the device 104 with the lower battery level, as that device 104 is less likely to be deployed for use in the facility before staging is complete. Battery levels and other device attributes can be obtained via the communications interface of the rack 108.

When more than one network-hosted staging source is available and the network-hosted mode has been selected, the server 124 can compare usage levels among the available staging sources and select the source with the lowest current usage level.

At block 330, when the server 124 has selected a staging mode and source, the server 124 is configured to send a source identifier to the device 104-2. In addition, at block 335 the server 124 is configured to send at least one access control command. A variety of access control commands are contemplated, and which commands are sent depends in part on the selected staging mode and source.

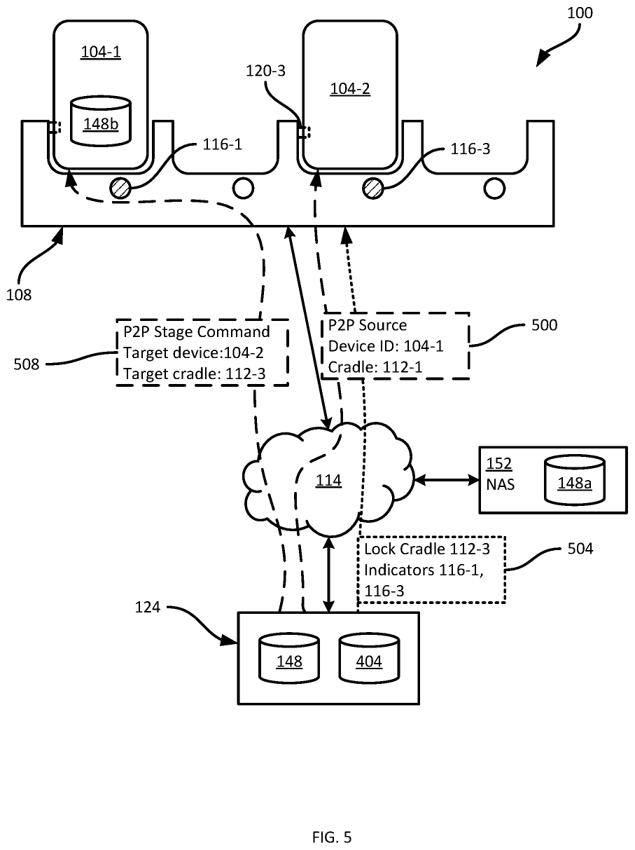

FIG. 5 illustrates an example performance of blocks 330 and 335, for the P2P staging mode, in which the device 104-1 has been selected as a staging source. In particular at block 330 the server 124 sends a message 500 to the device 104-2 containing an identifier of the device 104-1. In the present example, the message 500 identifies the device 104-1 by the device identifier “104-1” as well as the cradle 112 in which the device 104-1 is inserted (e.g. a port number or the like).

The server 124 also sends, at block 335, a first access control command 504 and a second access control command 508. The first command 504 is a command to the rack 108 itself, and includes instructions to lock the cradle 112-3 in which the device 104-2 was inserted. As a result, the controller of the rack 108 activates a lock 120-3 to retain the device 104-2 within the cradle 112-3. The command 504 also includes, in this example, an instruction to illuminate the indicators 116-1 and 116-3, to indicate that the devices 104-1 and 104-2 are busy. The command 504 can include additional instructions, such as a color of illumination to apply to the indicators 116, or the like. As seen in FIG. 5, the indicators 116-1 and 116-3 are illuminated as a result of the command 504. In other examples, if the lock 120-1 was not already engaged, the command 504 can also include an instruction to engage the lock 120-1.

The command 508 is sent to the device 104-1 itself, and is a command to begin operating as a staging source. For example, the receipt of the command 508 may cause the device 104-1 to begin execution of the application 220 to make the staging data 148b available to the device 104-2 locally (i.e. within the rack 108, via the internal networking interface of the rack 108). Once the staging source and access control commands have been sent, the devices 104-1 and 104-2 may interact to provide the staging data to the device 104-2. The devices 104-1 and 104-2 may communicate over the wired connections of the rack 108, or may establish a wireless connection (e.g. via Bluetooth, P2P Wi-Fi, or other suitable short-range connections).

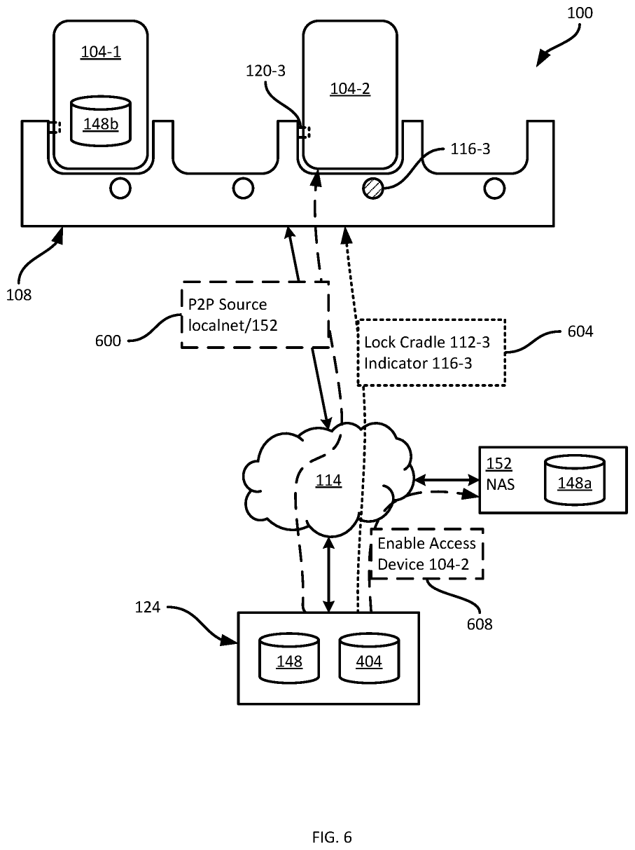

Referring to FIG. 6, another set of access control commands is shown, in response to selection of the NAS 152 as a staging source. In particular, the server 124 sends a message 600 to the device 104-2 identifying the NAS 152 as the source for staging data. The message 600 can contain, for example, a uniform resource identifier (URI) enabling the device 104-2 to request the staging data 148a from the NAS 152. The server 124 also sends access control commands 604, to the rack 108, and 608, to the NAS 152.

The command 604 instructs the rack 108 to engage the lock 120-3 and illuminate the indicator 116-3 as mentioned above in connection with FIG. 5. The command 608, meanwhile, instructs the NAS 152 to permit the device 104-2 to access the staging data 148a, e.g. for a predetermined period of time. In other examples, the staging data 148a is available to any computing device connected to the network 114 at any time, and the command 608 can therefore be omitted.

The access control commands shown in FIGS. 5 and 6 can be generated via the application 140 of the server 124, or via execution of the application 144 following access requests from the application 140. For example, the application 140 can select the staging mode and source, and request access to the source from the application 144. The application 144 can then control access to the source.

Returning to FIG. 3, at block 340 the device 104-2 receives the source identifier from the server 124, and requests the staging data from the source identified therein. At block 345, the device 104-2 receives and processes the staging data (e.g. 148, 148a or 148b, depending on the source). Processing the staging data, as will be apparent to those skilled in the art, includes installing applications and/or storing configuration data at the device 104-2. When the processing at block 345 is complete and the device 104-2 is fully staged, at block 350 the device 104-2 notifies the server 124 that staging is complete. Following receipt of the notification, at block 355 the server 124 can be configured to update access control implemented via the commands from block 335.

For example, at block 355 the server 124 can be configured to instruct the rack 108 to unlock a device 104 used as a P2P staging source, and/or to update the control of the corresponding indicator 116 (e.g. to indicate that the device 104 is ready for use, rather than busy). In other examples, the server 124 can send a further access control command to the NAS 152 to disable access to the staging data 148a. In addition, the server 124 may add the device 104-2 to a list of active devices (e.g. devices that are available for deployment) maintained by the server 124.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method of staging mobile computing devices, the method comprising, at a computing device:
receiving a staging request from a mobile computing device in response to insertion of the mobile computing device in a network-connected charging rack;
selecting a source of staging data to fulfill the staging request;
sending a source identifier of the selected source of staging data to the mobile computing device; and
in response to sending the source identifier of the selected source of staging data, sending an access control command to the network-connected charging rack to lock the mobile computing device in the charging rack.

2. The method of claim 1, further comprising: responsive to obtaining the staging request and prior to selecting the source of staging data, determining that the mobile computing device is authorized for staging.

3. The method of claim 2, wherein determining that the mobile computing device is authorized includes comparing a device identifier from the staging request to a set of authorized device identifiers maintained at the server.

4. The method of claim 1, wherein the charging rack includes a plurality of cradles; and
wherein the access control command includes a command to the charging rack to activate a lock of one of the cradles housing the mobile computing device.

5. The method of claim 4, wherein the access control command further includes a command to activate a device status indicator associated with the one of the cradles.

6. The method of claim 1, further comprising: responsive to completion of staging of the mobile computing device, sending a further access control command to enable release of the mobile computing device from the charging rack.

7. The method of claim 1, wherein selecting the source of staging data includes selecting between a peer-to-peer (P2P) staging mode, and a network-hosted staging mode.

8. The method of claim 7, wherein the selecting includes determining whether a second mobile computing device is connected to the charging rack.

9. The method of claim 8, wherein the access control command includes a command to the charging rack to activate a second lock of a second cradle housing the second mobile computing device.

10. The method of claim 7, wherein the selecting includes determining whether a usage level for a network-hosted storage location is below a threshold.

11. The method of claim 10, wherein the access control command includes a command to enable access to the network-hosted storage location.

12. A computing device, comprising:
a communications interface; and
a processor configured to:
receive a staging request from a mobile computing device in response to insertion of the mobile computing device in a network-connected charging rack;
select a source of staging data to fulfill the staging request;
send a source identifier of the selected source of staging data to the mobile computing device; and
in response to sending the source identifier of the selected source of staging data, send an access control command to the network-connected charging rack to lock the mobile computing device in the charging rack.

13. The computing device of claim 12, wherein the processor is further configured, responsive to obtaining the staging request and prior to selecting the source of staging data, to determine that the mobile computing device is authorized for staging.

14. The computing device of claim 13, wherein the processor is configured, to determine that the mobile computing device is authorized, to compare a device identifier from the staging request to a set of authorized device identifiers maintained at the server.

15. The computing device of claim 12, wherein the charging rack includes a plurality of cradles; and
wherein the access control command includes a command to the charging rack to activate a lock of one of the cradles housing the mobile computing device.

16. The computing device of claim 15, wherein the access control command further includes a command to activate a device status indicator associated with the one of the cradles.

17. The computing device of claim 12, wherein the processor is further configured, responsive to completion of staging of the mobile computing device, to send a further access control command to enable release of the mobile computing device from the charging rack.

18. The computing device of claim 12, wherein the processor is configured, to select the source of staging data, to select between a peer-to-peer (P2P) staging mode, and a network-hosted staging mode.

19. The computing device of claim 18, wherein the processor is configured, to select the source of staging data, to determine whether a second mobile computing device is connected to the charging rack.

20. A system, comprising:
a charging rack including a plurality of cradles and a network interface interconnecting the cradles; and
a computing device including a communications interface and a processor configured to:
receive a staging request from a mobile computing device in response to insertion of the mobile computing device in the charging rack;
select a source of staging data to fulfill the staging request;
send a source identifier of the selected source of staging data to the mobile computing device; and
in response to sending the source identifier of the selected source of staging data, send an access control command to the charging rack to lock the mobile computing device in the charging rack.
